(19) United States
(12) Patent Application Publication
(10) Pub. No.: US 2022/0296036 A1
(43) Pub. Date: Sep. 22, 2022

(54) Chafing Dish Wind Shield Assembly

(71) Applicants: Eugene Kimmons, Las Vegas, NV (US); Annette Kimmons, Las Vegas, NV (US)

(72) Inventors: Eugene Kimmons, Las Vegas, NV (US); Annette Kimmons, Las Vegas, NV (US)

(21) Appl. No.: 17/203,955

(22) Filed: Mar. 17, 2021

(51) Int. Cl. A47J 36/24; A47J 36/34; F24C 15/28

(52) U.S. Cl. CPC A47J 36/2405; A47J 36/34; F24C 15/28

(57) ABSTRACT

A chafing dish wind shield assembly for inhibiting chafing burners from being extinguished by wind includes a band that is comprised of a flexible material thereby facilitating the band to be formed into a closed shape to surround a chafing dish. The band is comprised of a fluid impermeable material to inhibit air from passing therethrough and extinguishing burners positioned beneath the chafing dish. Additionally, the band is comprised of a flame retardant material to inhibit the band from catching flame due to the burners. The band is matable to itself when the band is formed into the closed shape for retaining the band around the chafing dish.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wind shield device and more particularly pertains to a new wind shield device for protecting chafing burners from being extinguished by wind. The device includes a band that has a plurality of air vents and mating members for forming the band into a closed shape for surrounding the chafing burners.

### (2) Description of Related Art Including Information Disclosed Under 37 CFR 1.97 and 1.98

The prior art relates to wind shield devices including a variety of preformed barriers that are positionable around a chafing dish to protect chafing burners from wind. The prior art also discloses a variety of skirts that are positionable around a chafing dish to protect chafing burners from wind. In no instance does the prior art disclose a band that is matable to itself to surround chafing burners and which has air vents extending therethrough.

### BRIEF SUMMARY OF THE INVENTION

An embodiment of the disclosure meets the needs presented above by generally comprising a band that is comprised of a flexible material thereby facilitating the band to be formed into a closed shape to surround a chafing dish. The band is comprised of a fluid impermeable material to inhibit air from passing therethrough and extinguishing burners positioned beneath the chafing dish. Additionally, the band is comprised of a flame retardant material to inhibit the band from catching flame due to the burners. The band is matable to itself when the band is formed into the closed shape for retaining the band around the chafing dish.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a chafing dish wind shield assembly according to an embodiment of the disclosure.

FIG. 2 is a front view of an embodiment of the disclosure.

FIG. 3 is a top view of an embodiment of the disclosure.

FIG. 4 is a perspective in-use view of an embodiment of the disclosure showing a band being lowered around a chafing dish

FIG. 5 is a perspective in-use view of an embodiment of the disclosure showing a band extending around a chafing dish.

### DETAILED DESCRIPTION OF THE INVENTION

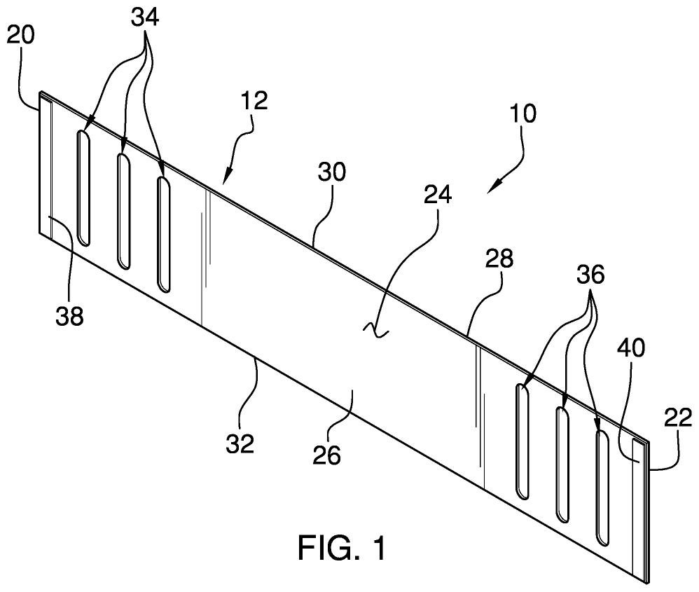

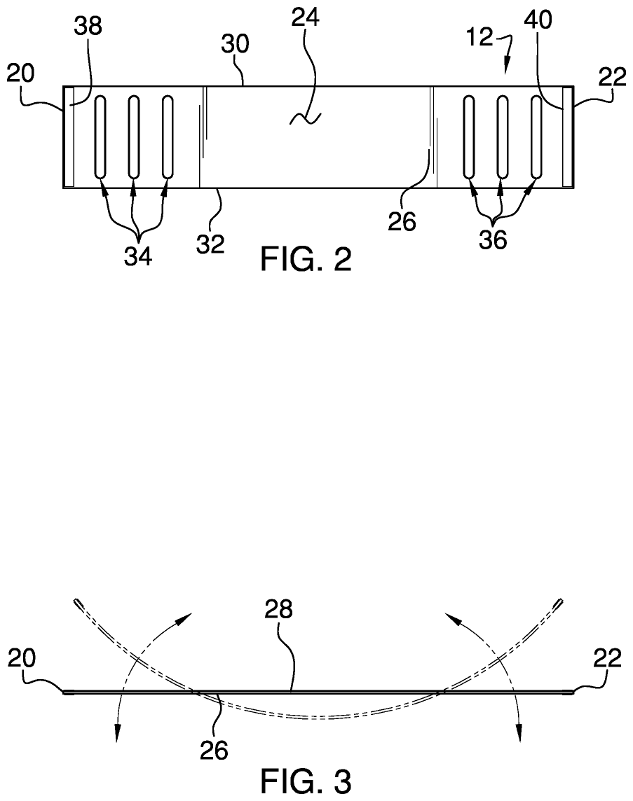

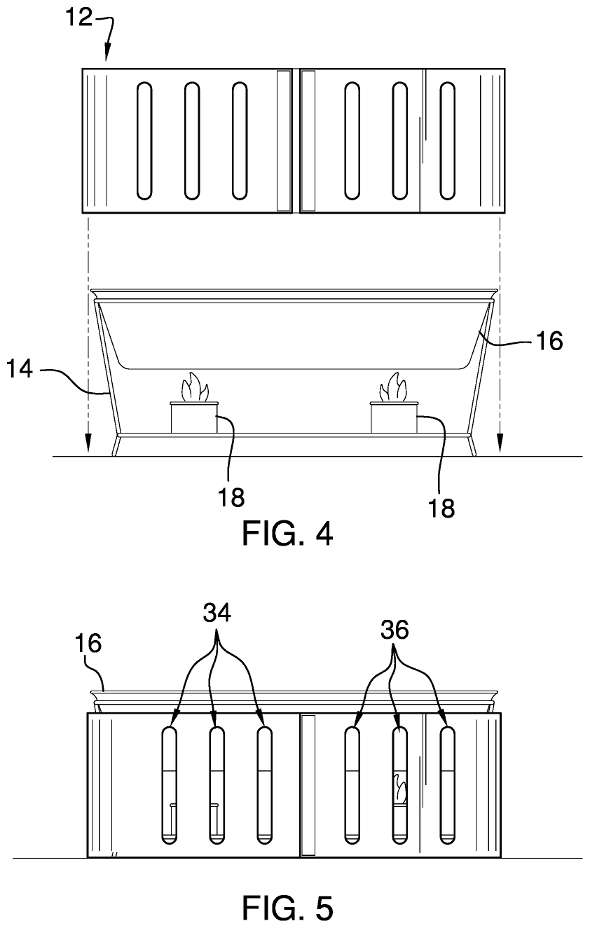

With reference now to the drawings, and in particular to FIGS. 1 through 5 thereof, a new wind shield device embodying the principles and concepts of an embodiment of the disclosure and generally designated by the reference numeral 10 will be described.

As best illustrated in FIGS. 1 through 5, the chafing dish wind shield assembly 10 generally comprises a band 12 that is comprised of a flexible material thereby facilitating the band 12 to be formed into a closed shape. In this way the band 12 can surround a stand 14 upon which a chafing dish 16 is positioned. The closed shape may be an ovoid, a circle or any other type of closed shape. The band 12 is comprised of a fluid impermeable material, including but not being limited to, plastic or tin, to inhibit air from passing therethrough and extinguishing burners 18 that are positioned beneath the chafing dish 16. The band 12 is comprised of a flame retardant material to inhibit the band 12 from catching flame due to the burners 18. The burners 18 might be chafing burners that burn combustible fuel for warming food that is positioned in the chafing dish 16.

The band 12 is matable to itself when the band 12 is formed into the closed shape for retaining the band 12 around the chafing dish 16. The band 12 has a first end 20, a second end 22 and an outer surface 24 extending therebetween, and the outer surface 24 has a first side 26 and a second side 28. The band 12 has a top edge 30 and a bottom edge 32 each extending between the first end 20 and the second end 22, and the band 12 is elongated between the first end 20 and the second end 22. The band 12 may have a length of at least 5.0 feet, a height of at least 12.0 inches and a width of at least 12.0 inches.

The band 12 has a plurality of first slots 34 each extending through the first side 26 and the second side 28 of the outer surface 24 to pass air therethrough to facilitate combustion of the burners 18. Each of the first slots 34 is elongated to extend substantially between the top edge 30 and the bottom edge 32 of the band 12. Additionally, each of the first slots 34 is spaced apart from each other and is distributed from the first end 20 toward the second end 22. The band 12 has a plurality of second slots 36 each extending through the first side 26 and the second side 28 of the outer surface 24 to pass air therethrough to facilitate combustion of the burners 18. Each of the second slots 36 is elongated to extend substantially between the top edge 30 and the bottom edge 32 of the band 12. Additionally, each of the second slots 36 is spaced apart from each other and is distributed from the second end 22 toward the first end 20. The plurality of first slots 34 is spaced apart from the plurality of second slots 36.

A first mating member 38 is coupled to the first side 26 of the outer surface 24 of the band 12. The first mating member 38 is positioned adjacent to the first end 20 and the first mating member 38 extends between the top edge 30 and the bottom edge 32. A second mating member 40 is provided and the second mating member 40 is coupled to the first side 26 of the outer surface 24 of the band 12. The second mating member 40 is positioned adjacent to the second end 22 and the second mating member 40 extends between the top edge 30 and the bottom edge 32. The second mating member 40 is matable to the first mating member 38 when the band 12 is formed into the closed shape for retaining the band 12 in the closed shape. Each of the first mating member 38 and the second mating member 40 may comprise magnets, hook and loop fasteners, adhesive pads, or any other type of multiple use, releasable mating member.

In use, the band 12 is wrapped around the stand 14 upon which the chafing dish 16 is positioned and the first mating member 38 is mated to the second mating member 40. In this way the band 12 surrounds the burners 18 that are positioned beneath the chafing dish 16. Thus, the band 12 protects the burners 18 from wind that could potentially extinguish the burners 18 when the burners 18 are employed outdoors. Additionally, the first slots 34 and the second slots 36 ensure that the burners 18 have adequate air flow to facilitate combustion. The band 12 is removed from around the stand 14 when the burners 18, the stand 14 and the chafing dish 16 are finished being used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A chafing dish wind shield assembly for protecting burners placed beneath a chafing dish from being extinguished by wind, said assembly comprising:
a band being comprised of a flexible material thereby facilitating said band to be formed into a closed shape wherein said band is configured to surround a chafing dish, said band being comprised of a fluid impermeable material wherein said band is configured to inhibit air from passing therethrough and extinguishing burners positioned beneath the chafing dish, said band being comprised of a flame retardant material wherein said band is configured to inhibit from catching flame due to the burners, said band being matable to itself when said band is formed into said closed shape wherein said band is configured to be retained around the chafing dish, said band having a plurality of air vents each extending wherein said plurality of air vents is configured to pass air therethrough to facilitate combustion of the burners.

2. The assembly according to claim 1, wherein:
said band has a first end, a second end and an outer surface extending therebetween, said outer surface having a first side and a second side, said band having a top edge and a bottom edge each extending between said first end and said second end, said band being elongated between said first end and said second end; and
said band has a plurality of first slots each extending through said first side and said second side of said outer surface to define respective ones of said air vents wherein each of said first slots is configured to pass air therethrough for facilitating combustion of the burners.

3. The assembly according to claim 2, wherein each of said first slots is elongated to extend substantially between said top edge and said bottom edge of said band, each of said first slots being spaced apart from each other and being distributed from said first end toward said second end.

4. The assembly according to claim 1, wherein said band has a plurality of second slots each extending through said first side and said second side of said outer surface to define respective ones of said air vents wherein each of said second slots is configured to pass air therethrough for facilitating combustion of the burners.

5. The assembly according to claim 4, wherein each of said second slots is elongated to extend substantially between said top edge and said bottom edge of said band, each of said second slots being spaced apart from each other and being distributed from said second end toward said first end, said plurality of first slots being spaced apart from said plurality of second slots.

6. The assembly according to claim 1, wherein:
said band has a first end, a second end and an outer surface extending therebetween, said outer surface having a first side and a second side, said band having a top edge and a bottom edge each extending between said first end and said second end, said band being elongated between said first end and said second end; and
said assembly includes a first mating member being coupled to said first side of said outer surface of said band, said first mating member being positioned adjacent to said first end, said first mating member extending between said top edge and said bottom edge.

7. The assembly according to claim 6, further comprising a second mating member being coupled to said first side of said outer surface of said band, said second mating member being positioned adjacent to said second end, said second mating member extending between said top edge and said bottom edge, said second mating member being matable to said first member when said band is formed into the closed shape for retaining said band in the closed shape.

8. A chafing dish wind shield assembly for protecting burners placed beneath a chafing dish from being extinguished by wind, said assembly comprising:
a band being comprised of a flexible material thereby facilitating said band to be formed into a closed shape wherein said band is configured to surround a chafing dish, said band being comprised of a fluid impermeable material wherein said band is configured to inhibit air from passing therethrough and extinguishing burners positioned beneath the chafing dish, said band being comprised of a flame retardant material wherein said band is configured to inhibit from catching flame due to the burners, said band being matable to itself when said band is formed into said closed shape wherein said band is configured to be retained around the chafing dish, said band having a plurality of air vents each extending wherein said plurality of air vents is configured to pass air therethrough to facilitate combustion of the burners, said band having a first end, a second end and an outer surface extending therebetween, said outer surface having a first side and a second side, said band having a top edge and a bottom edge each extending between said first end and said second end, said band being elongated between said first end and said second end, said band having a plurality of first slots each extending through said first side and said second side of said outer surface to define respective ones of said air vents wherein each of said first slots is configured to pass air therethrough for facilitating combustion of the burners, each of said first slots being elongated to extend substantially between said top edge and said bottom edge of said band, each of said first slots being spaced apart from each other and being distributed from said first end toward said second end, said band having a plurality of second slots each extending through said first side and said second side of said outer surface to define respective ones of said air vents wherein each of said second slots is configured to pass air therethrough for facilitating combustion of the burners, each of said second slots being elongated to extend substantially between said top edge and said bottom edge of said band, each of said second slots being spaced apart from each other and being distributed from said second end toward said first end, said plurality of first slots being spaced apart from said plurality of second slots;
a first mating member being coupled to said first side of said outer surface of said band, said first mating member being positioned adjacent to said first end, said first mating member extending between said top edge and said bottom edge; and
a second mating member being coupled to said first side of said outer surface of said band, said second mating member being positioned adjacent to said second end, said second mating member extending between said top edge and said bottom edge, said second mating member being matable to said first member when said band is formed into the closed shape for retaining said band in the closed shape.

9. A chafing dish wind shield system for protecting burners placed beneath a chafing dish from being extinguished by wind, said system comprising:
a chafing dish being configured to contain a food product;
a stand having said chafing dish being positioned thereon wherein said stand is configured to support said chafing dish above a support surface;
a plurality of burners, each of said burners burning a combustible fuel when said burners are ignited, each of said burners being positionable beneath said chafing dish wherein each of said burners is configured to warm the food item in said chafing dish;
a band being comprised of a flexible material thereby facilitating said band to be formed into a closed shape to surround said chafing dish, said band being comprised of a fluid impermeable material wherein said band is configured to inhibit air from passing therethrough and extinguishing said burners positioned beneath said chafing dish, said band being comprised of a flame retardant material wherein said band is configured to inhibit from catching flame due to said burners, said band being matable to itself when said band is formed into said closed shape for retaining said band around said stand, said band having a first end, a second end and an outer surface extending therebetween, said outer surface having a first side and a second side, said band having a top edge and a bottom edge each extending between said first end and said second end, said band being elongated between said first end and said second end, said band having a plurality of first slots each extending through said first side and said second side of said outer surface wherein each of said first slots is configured to pass air therethrough for facilitating combustion of said combustible fuel in said burners, each of said first slots being elongated to extend substantially between said top edge and said bottom edge of said band, each of said first slots being spaced apart from each other and being distributed from said first end toward said second end, said band having a plurality of second slots each extending through said first side and said second side of said outer surface wherein each of said second slots is configured to pass air therethrough for facilitating combustion of said combustible fuel in said burners, each of said second slots being elongated to extend substantially between said top edge and said bottom edge of said band, each of said second slots being spaced apart from each other and being distributed from said second end toward said first end, said plurality of first slots being spaced apart from said plurality of second slots;
a first mating member being coupled to said first side of said outer surface of said band, said first mating member being positioned adjacent to said first end, said first mating member extending between said top edge and said bottom edge; and
a second mating member being coupled to said first side of said outer surface of said band, said second mating member being positioned adjacent to said second end, said second mating member extending between said top edge and said bottom edge, said second mating member being matable to said first member when said band is formed into the closed shape for retaining said band in the closed shape.
